(19) United States
(12) Patent Application Publication
(10) Pub. No.: US 2015/0284982 A1
(43) Pub. Date: Oct. 8, 2015

(54) DOOR COLLAR LOCK

(71) Applicant: Daniel Nietzel, Muscatine, IA (US)

(72) Inventor: Daniel Nietzel, Muscatine, IA (US)

(21) Appl. No.: 14/244,091

(22) Filed: Apr. 3, 2014

(51) Int. Cl. E05F 3/22; E05B 65/06; E05B 15/02

(52) U.S. Cl. CPC E05F 3/227; E05B 15/02; E05B 65/06

(57) ABSTRACT

An apparatus holds a door closed comprising: a top panel, a left wall and a right wall. A flap is attached to the left wall opposite the top panel and folded under the apparatus. A flap is attached to the right wall opposite the top panel and folded under the apparatus. The apparatus contains a front end, a back end and an opening at the front end that has a larger cross section than a cross section of the back end thereby providing for a tapered shape of the apparatus overall, such that the apparatus is configured to fit over two hinged arms of a door closing system, preventing the arms from articulating open to prevent the door from opening.

### CROSS REFERENCE TO RELATED APPLICATIONS

This is a continuation-in-part of U.S. patent application Ser. No. 14/099,912 filed Dec. 7, 2013.

### FIELD OF THE INVENTION

The present invention generally relates to a door collar lock. More specifically, the invention relates to a system and method for securing a door in a closed position using a door collar locking device.

### BACKGROUND OF THE INVENTION

The use of door closing mechanisms having a rod and associated piston operating within a cylinder is well known. For instance, in residential applications, it is well known to connect such a mechanism between the door and its frame to act as a shock absorber or dampener against the action of a closing force such as a spring or a partial vacuum within the cylinder.

It has been known to provide different types of stops in conjunction with such closing mechanisms, which allow the door to be closed only partially, thereby temporarily maintaining the door in the desired position against the closing force. One of the more common types of prior art devices consists of a stop washer mounted on the piston rod. The washer is wedged between the rod and the cylinder to prevent the rod from being drawn in to the cylinder.

While different ways of temporarily keeping a door having a pneumatic piston and rod mechanism open have been contemplated and made available, few systems have focused on keeping a door with a pneumatic piston and rod closed for emergency purposes.

Recent tragic events such as those at Sandy Hook Elementary School in Connecticut, Columbine High School, and other locations, have prompted discussions on ways to improve security in schools and in other venues. In some instances, due to fire code regulations, and the like, the use of door locks may be disallowed. Still, even door locks may be vulnerable to forced entry because typical door locks are easily kicked-in or pushed open by blunt and sudden force.

Therefore, there is still a need for a system and method that overcomes the shortcomings of the above-mentioned prior art. The system and method described herein provides such a system and method by preventing opening of a door with a pneumatic piston and rod mechanism.

### SUMMARY OF THE INVENTION

According to a preferred embodiment, an apparatus for holding a door closed, comprising: a top panel; a left wall; a right wall; a flap attached to the left wall opposite the top panel and folded under the apparatus; a flap attached to the right wall opposite the top panel and folded under the apparatus; a front end; a back end; and an opening at the front end that has a larger cross section than a cross section of the back end thereby providing for a tapered shape of the apparatus overall, such that the apparatus is configured to fit over two hinged arms of a door closing system, preventing the arms from articulating open to prevent the door from opening.

According to another preferred embodiment, a door collar lock, comprising: a top panel; a left wall; a right wall; a front end; a back end; a flap attached to the left wall opposite the top panel and folded under the apparatus; a flap attached to the right wall opposite the top panel and folded under the apparatus; and an opening at the front end that has a larger cross section than a cross section of the back end thereby providing for a tapered shape of the door collar lock overall, such that the door collar lock is configured to fit over two hinged arms of a door closing system, preventing the arms from articulating open to prevent the door from opening.

### BRIEF DESCRIPTION OF THE DRAWINGS

FIG. 1 is a right front perspective view of a door collar lock according to one embodiment;

FIG. 2 is a top elevational view of the embodiment of FIG. 1;

FIG. 3 is a left perspective view of a door with a pneumatic or spring actuated arm and rod configuration, with the door collar lock installed to prevent the door from opening according to the embodiment of FIG. 1;

FIG. 4 is a bottom right perspective view of the door collar lock according to the embodiment of FIG. 1 installed to prevent the rods from scissoring outwardly to a more oblique angle so as to prevent opening of the door;

FIG. 5 illustrates an alternative embodiment of the door collar lock that includes wheels on small carriages configured to roll along a mount on the door frame, on the side of one of the rods and or on one of the rods itself;

FIG. 6 illustrates yet another alternative embodiment of the door collar lock with one or more magnets attached to the top as a mounting mechanism;

FIG. 7 illustrates yet another alternative embodiment of the door collar lock with one or more wall mounting holes located in the top;

FIG. 8 illustrates yet another alternative embodiment of the door collar lock with a mounting;

FIG. 9 illustrates yet another alternative embodiment of the door collar lock is shown with a knob to allow for more clearance for a hinge;

FIG. 10 illustrates yet another alternative embodiment of the door collar lock with a bevel that may allow the device to be more easily tightened around smaller;

FIG. 11 illustrates yet another alternative embodiment of the door collar lock with an extension or insert having a ridge configured to slide into the opening of the device to extend the length of the device for adjustment for shorter or longer arms;

FIG. 12 is a bottom, front perspective view of an alternative embodiment of the door collar lock;

FIG. 13 is a bottom left perspective view of the embodiment of FIG. 12; and

FIG. 14 is a left perspective view of a door with a pneumatic or spring actuated arm and rod configuration, with the embodiment of FIGS. 12 and 13 installed to prevent the door from opening.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

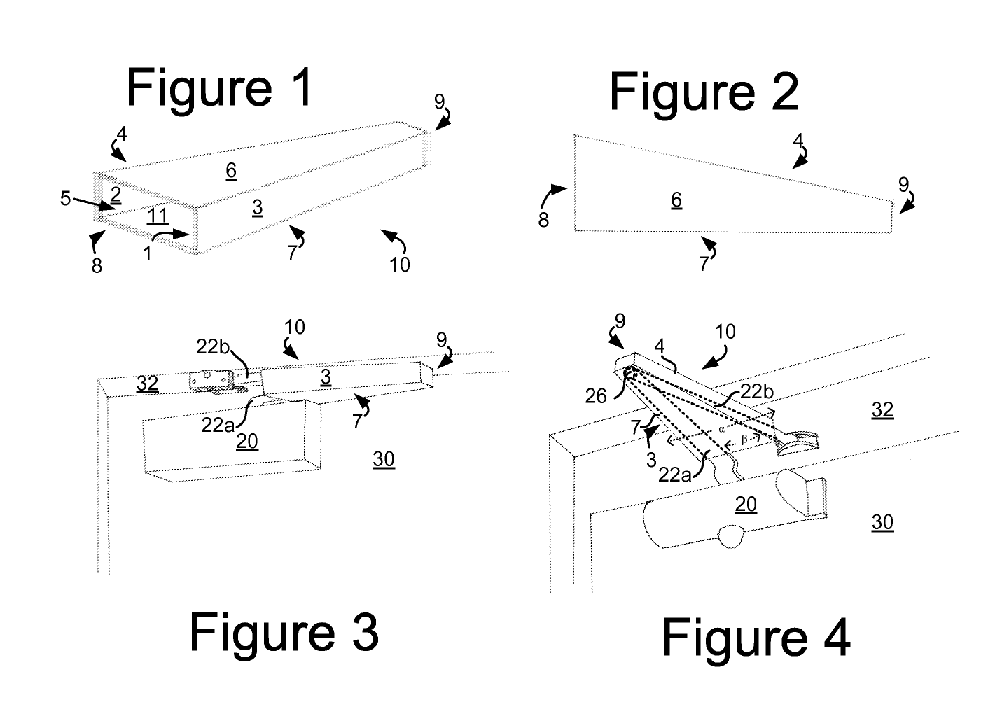

Broadly, embodiments of the present invention generally provide a door collar lock that can be easily installed over the rods of a pneumatic door mechanism to prevent entry. With reference to FIG. 1, a right front perspective view of a door collar lock 10 is shown according to one embodiment. In one embodiment, the door collar lock 10 may comprise a front end 8, a back end 9, a left wall 4 (having an inner wall 2), and a right wall 3 (having an inner wall 1). The front end 8 may comprise an opening 5, which may have a planar area that may be smaller than the cross section of the front end 9, providing for a tapered shape of the door collar lock 10 overall.

The relative triangular shapes of a top panel 6 of the door collar lock 10, and a bottom panel 7 illustrate the tapering from back to front of the door collar lock 10, as also illustrated in the partial view of the inner wall 11 of the bottom panel 7.

With reference to FIG. 2, a top elevational view of the door collar lock 10 of FIG. 1 is shown. The tapered shape of the door collar lock 10 is illustrated in FIG. 2, more specifically as illustrated by the shape of the top panel 6.

With reference to FIG. 3, a left perspective view of a door 30 with a pneumatic or spring actuated arm and rod configuration is shown, with the door collar lock 10 installed to prevent the door 30 from opening according to the embodiment of FIG. 1. The rod or elbow 22a and 22b may consist of two articulating elongated members 22a and 22b over which the door collar 10 may be fitted by insertion over the elongated members 22a and 22b. Normally, the two elongated members 22a and 22b are free to articulate as allowed or caused by the pneumatic, hydraulic, or spring piston 20. While the piston 20 may bias the elongated members 22a and 22b to push the door 30 into the closed position with respect to the door frame 32, such a bias toward closing does not function as a lock. A person of average or low strength may still push the door open with little or no effort, as designed. However, in an emergency situation, it may be desirable to push the door collar lock 10 over the arms 22a and 22b.

With reference to FIG. 4, a bottom right perspective view of the door collar lock 10 installed to prevent the rods 22a and 22b from scissoring outwardly to a more oblique angle α so as to prevent opening of the door 30 is shown. The rods 22a and 22b are shown in phantom for the portion covered by the door collar lock 10, and the hinge 26 between the rods 22a and 22b is further illustrated in phantom. The door collar lock 10 functions to keep the rods 22a and 22b at a relatively more acute angle β rather than when the door 30 is in the open position with respect to the frame 32. In one embodiment, the angle β comprises an angle by which the door 30 is substantially in a closed position with respect to the door frame 32, so as to prevent entry by a potential wrong doer in an emergency. In one embodiment, the angle α comprises a wider angle than angle β, so as to prevent or deter a wrong doer from entry in an emergency.

As shown in FIG. 4, the elongated design of the sides 3 and 4 of the door collar lock 10 functions to provide a distributed pressure along some or most of the length of the rods 22a and 22b when there is attempt to force the door 30 open. Having this elongated length and pressure along the rods 22a and 22b, as opposed to just one small portion of the rods 22a and 22b, makes for a more rigid stoppage of the door 30 from opening. The larger area of distribution of the pressure along the sides 3 and 4, and the planar surface areas of the top (6 in FIGS. 1 and 2) and bottom 7 of the door collar lock 10 further provides more rigidity.

Put another way, the left wall 3 and the wall 4 are configured at an angle with respect to each other so as to contact a relative substantial part of side surface areas of the arms 22a and 22b for increased distribution of force placed by the arms on the apparatus 10 as opening force is placed on the door 30. In this respect, the top 6 and bottom 7 comprise solid substantially triangular plates so as to further distribute the force placed on the apparatus 10 by the arms 22a and 22b as opening force is placed on the door 30.

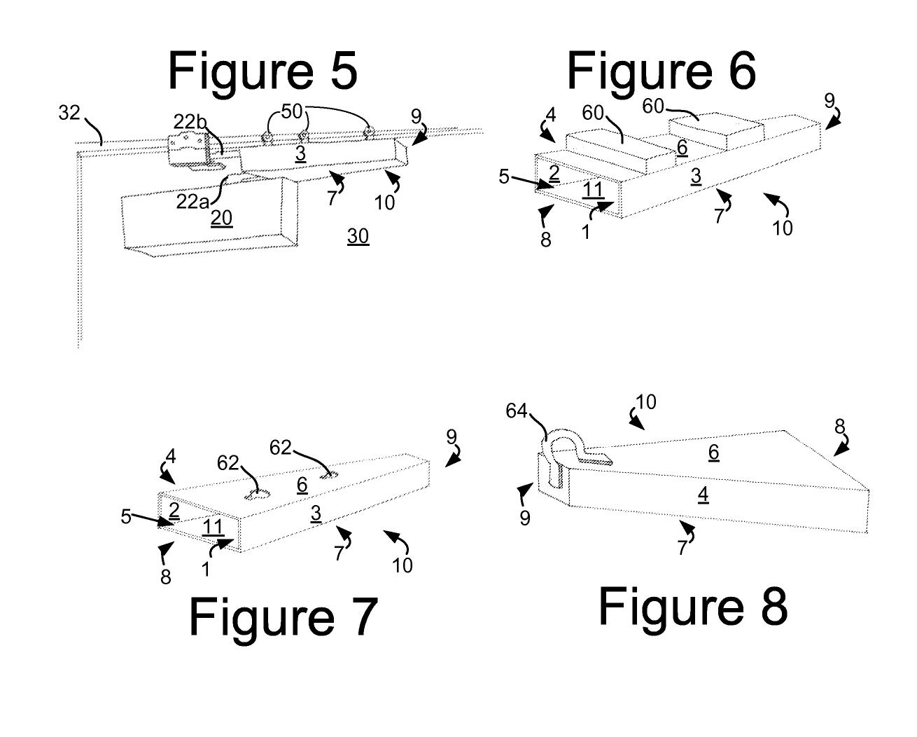

FIGS. 5-9 illustrate various embodiments that provide for various storage solutions for the door collar lock 10. Storage at or in the general area of the door collar lock 10 may prevent, for example, a teacher in a classroom, or manager in an office, from having to search for the door collar lock 10 in an extreme panic during an emergency. For example, with specific reference to FIG. 5, an alternative embodiment of the door collar lock 10 includes wheels 50 on small carriages configured to roll along a mount on the door frame 32, on the side of one of the rods 22a and 22b, or on one of the rods 22a itself. The door collar lock 10 can then be stored to the side of the rods 22a and 22b when not in use, but then rolled into position when the door 30 is closed, over both of the rods 22a and 22b, during an emergency when in use, as shown in position in FIG. 5.

With reference to FIG. 6, yet another alternative embodiment of the door collar lock 10 is shown with one or more magnets 60 attached to the top 6 as a mounting mechanism. In this embodiment, the door collar lock 10 may be magnetically attached to a steal structure, such as the door 30 or door frame 32 when not in use, but remain easily accessible during an emergency.

With reference to FIG. 7, yet another alternative embodiment of the door collar lock 10 is shown with one or more wall mounting holes 70 located in the top 6 as a mounting mechanism. As with the magnets 60 in FIG. 6, the wall mounting holes 70 allow the door collar lock 10 to be position mounted in proximity to the door 30 by means of one or more nails or mounting brackets in the door 30 or wall near the door.

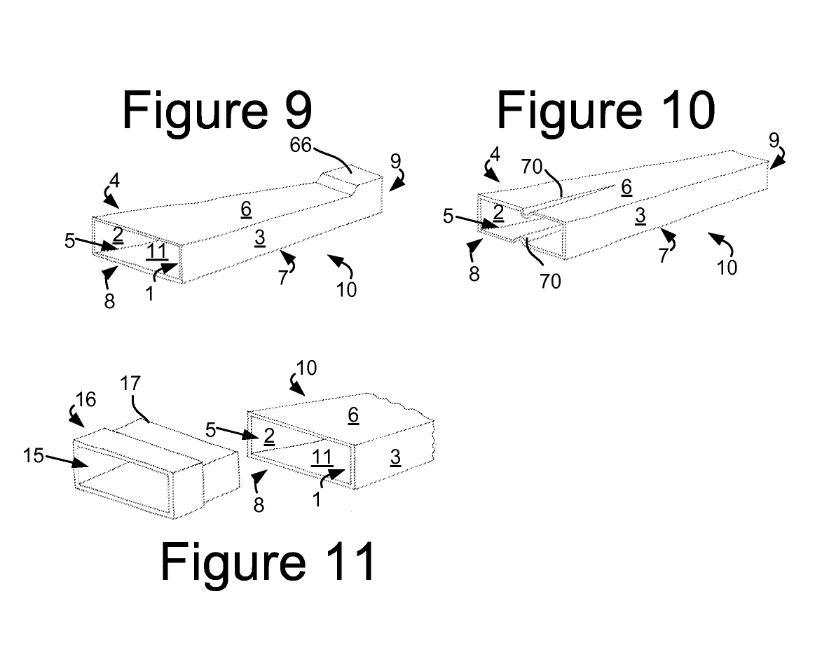

With reference to FIG. 8, yet another alternative embodiment of the door collar lock 10 is shown with a mounting hook 64 located in the top 6 as a mounting mechanism. The wall-mounting hook 64 allows the door collar lock 10 to be position mounted in proximity to the door 30 by means of a nail or mounting bracket in the door 30 or wall near the door.

With reference to FIG. 9, yet another alternative embodiment of the door collar lock 10 is shown with a knob 66 to allow for more clearance for the hinge 26 within the device 10 when mounted on the elbows or arms 22a and 22b.

With reference to FIG. 10, yet another alternative embodiment of the door collar lock 10 is shown with a bevel 70 that may allow the device 10 to be more easily tightened around smaller sized arms 22a and 22b.

With reference to FIG. 11, yet another alternative embodiment of the door collar lock 10 is shown with an extension or insert 16 having a ridge configured to slide into the opening 5 of the device 10 to extend the length of the device 10 for adjustment for shorter or longer arms 22a and 22b. After the extension 16 is inserted into the opening 5, the arms 22a and 22b are fit through the extension's opening 15.

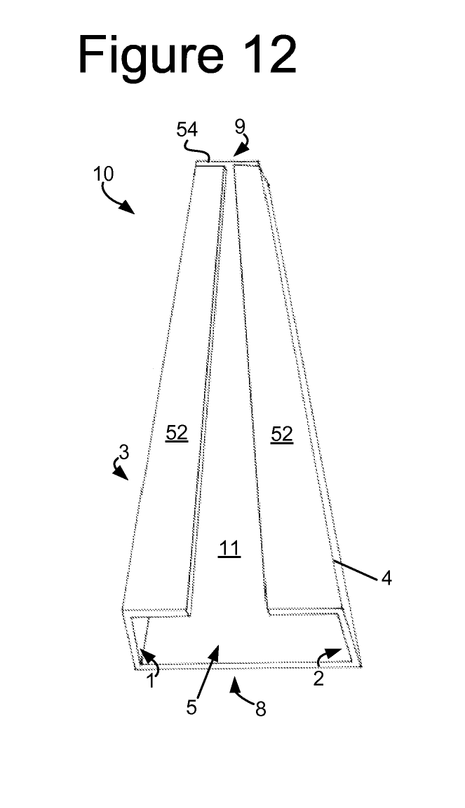

With reference to FIG. 12, a bottom, front perspective view of an alternative embodiment of the door collar lock 10 is shown. The embodiment of FIG. 12 may comprise an embodiment that eliminates any need for welding of the door collar lock 10. Instead of a having a solid bottom panel 7 as in the embodiments of FIGS. 1-11, the embodiment of FIG. 12 has a portion of the bottom panel cut out, with instead, two flaps 50 that extend from the sides 3 and 4 of the lock 10, bent into the bottom of the lock 10.

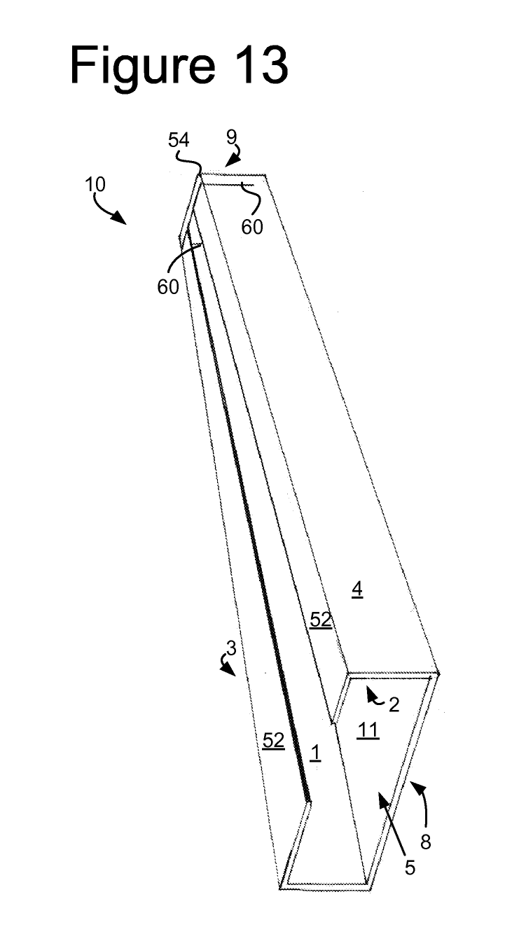

With reference to FIG. 13, a bottom left perspective view of the embodiment of FIG. 12 is shown. The top 9 of the door collar lock 10 may comprise an end cap 52 that is extended from the bottom panel 7, and which may not be directly connected to the sides 3 and 4 of the lock 10 for ease of manufacturing, which may result in slits 60 down the sides of the end cap 54 between the sides 3 and 4 and the end cap 54. Optionally, the end cap 54 may be attached, welded, or glued to the sides 3 and 4 after shaping of the lock 10 during manufacturing.

The embodiment of FIGS. 12 and 13 may allow the door collar lock 10 to be made by brake-pressing it. The whole pattern can be laid flat (from one geometric shape) and cut by a laser. Next, a brake machine may make five brakes to fold the finished brake press lock 10. There may be, for example, one brake for the end cap 54, and another brake for each side 3 and 4, and another two breaks to fold the flaps 52 that form the open channel on the bottom. This embodiment may cut down significantly on costs of manufacturing, without compromising strength. In this respect, in one embodiment, it may be advantageous to use a gauge of steel of sufficient thickness for the rigidity to cause toe creases or brakes in the lock 10 to remain substantially permanent during use to hold when the lock 10 is put under duress.

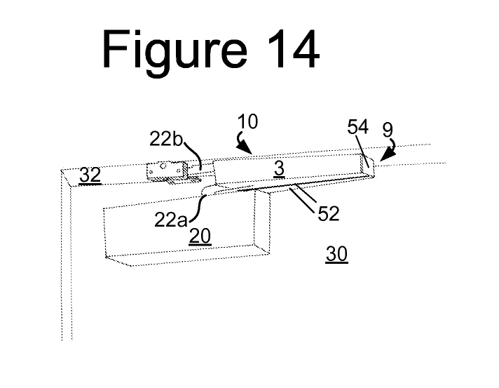

With reference to FIG. 14, a left perspective view of a door with a pneumatic or spring actuated arm and rod configuration, with the embodiment of FIGS. 12 and 13 installed to prevent the door from opening is shown. As shown in FIG. 14, even in the absence of a solid bottom 7 as with the embodiment of FIG. 3, the flaps 52 still provide enough force over the arms 22a and 22b to prevent a person from pushing the door open when the embodiment of FIG. 14 is installed over the arms 22a and 22b, functioning in the same way as the embodiment of FIG. 3.

It should be understood, of course, that the foregoing relates to exemplary embodiments of the invention and that modifications may be made without departing from the spirit and scope of the invention as set forth in the following claims.

1. An apparatus for holding a door closed, comprising:
a top panel;
a left wall;
a right wall;
a flap attached to the left wall opposite the top panel and folded under the apparatus;
a flap attached to the right wall opposite the top panel and folded under the apparatus;
a front end;
a back end; and
an opening at the front end that has a larger cross section than a cross section of the back end thereby providing for a tapered shape of the apparatus overall, such that the apparatus is configured to fit over two hinged arms of a door closing system, preventing the arms from articulating open to prevent the door from opening.

2. The apparatus of claim 1; wherein the left wall and the right wall are configured at an angle with respect to each other so as to contact a relative substantial part of side surface areas of the arms for increased distribution of force placed by the arms on the apparatus as opening force is placed on the door.

3. The apparatus of claim 2; wherein the top comprises a solid substantially triangular plate so as to further distribute the force placed on the apparatus by the arms as opening force is placed on the door.

4. The apparatus of claim 2; further comprising a mounting system configured to facilitate storage of the apparatus during non-use.

5. The apparatus of claim 3; wherein the mounting device comprises a wall-mounting hook.

6. The apparatus of claim 3; wherein the mounting device comprises one or more magnets.

7. The apparatus of claim 3; wherein the mounting device comprises one or more mounting holes.

8. The apparatus of claim 3; wherein the mounting device comprises one or more wheels and carriages configured to allow the apparatus to be slid over the rods.

9. The apparatus of claim 1; further comprising a knob configured to allow for additional clearance of a hinge.

10. The apparatus of claim 1; further comprising a bevel configured to allow the device to more easily be tightened around the arms.

11. The apparatus of claim 1; further comprising an extension that is configured to fit in the opening at the front end to provide for adjustment of the length of the apparatus for different lengths of arms.

12. A door collar lock, comprising:
a top panel;
a left wall;
a right wall;
a front end;
a back end;
a flap attached to the left wall opposite the top panel and folded under the apparatus;
a flap attached to the right wall opposite the top panel and folded under the apparatus; and
an opening at the front end that has a larger cross section than a cross section of the back end thereby providing for a tapered shape of the door collar lock overall, such that the door collar lock is configured to fit over two hinged arms of a door closing system, preventing the arms from articulating open to prevent the door from opening.

13. The door collar lock claim 12; wherein the left wall and the right wall are configured at an angle with respect to each other so as to contact a relative substantial part of side surface areas of the arms for increased distribution of force placed by the arms on the apparatus as opening force is placed on the door.

14. The door collar lock of claim 13; wherein the top panel comprises a solid substantially triangular plate so as to further distribute the force placed on the apparatus by the arms as opening force is placed on the door.

15. The door collar lock of claim 12; further comprising a mounting system configured to facilitate storage of the apparatus during non-use.

16. The door collar lock of claim 15; wherein the mounting device comprises a wall-mounting hook.

17. The door collar lock of claim 15; wherein the mounting device comprises one or more magnets.

18. The door collar lock of claim 15; wherein the mounting device comprises one or more mounting holes.

19. The door collar lock of claim 15; wherein the mounting device comprises one or more wheels and carriages configured to allow the apparatus to be slid over the rods.

20. The door collar lock of claim 12; further comprising a knob configured to allow for additional clearance of a hinge.

21. The door collar lock of claim 12; further comprising a bevel configured to allow the device to more easily be tightened around the arms.

22. The door collar lock of claim 12; further comprising an extension that is configured to fit in the opening at the front end to provide for adjustment of the length of the apparatus for different lengths of arms.
